(19) United States
(12) Patent Application Publication
(10) Pub. No.: US 2026/0266634 A1
(43) Pub. Date: Sep. 10, 2026

(54) SENSOR MODULE, LINEAR MOTION GUIDE DEVICE WITH SENSOR, AND LINEAR MOTION GUIDE DEVICE

(71) Applicant: THK CO., LTD., Tokyo (JP)

(72) Inventor: Masashi Sugiura, Tokyo (JP)

(73) Assignee: THK CO., LTD., Tokyo (JP)

(21) Appl. No.: 19/166,539

(22) PCT Filed: Mar. 12, 2024
(86) PCT No.: PCT/JP2024/009503

§ 371 Date: Sep. 18, 2025

(30) Foreign Application Priority Data
Mar. 22, 2023 (JP) 2023-045976

(51) Int. Cl. G01D 11/24; G01D 11/30; G01M 13/021

(52) U.S. Cl. CPC G01D 11/245; G01D 11/30; G01M 13/021

(57) ABSTRACT

Provided is a technology that improves the workability of installing a sensor module. A sensor module (1) includes a housing (10) that encloses a sensor (30), the housing (10) including a receptacle (12a) formed therein, the housing having secured thereto a sensor substrate (20), on which the sensor (30) and a pin module (40) are mounted, the pin module (40) having a contact pin (41) configured to output a signal from the sensor (30) inside the receptacle (12a).

### TECHNICAL FIELD

The present invention relates to a sensor module, a sensor-equipped linear motion guide device, and a linear motion guide device.

### BACKGROUND ART

A sensor module provided with a sensor that converts detected environmental changes into electrical signals and outputs them is known.

Patent Literature 1 discloses a temperature sensor assembly that includes a temperature sensor and a terminal for outputting a signal from the temperature sensor.

### CITATION LIST

### Patent Literature

### Patent Literature 1

Japanese Patent Application Publication, Tokukai, No. 2021-089281

### SUMMARY OF INVENTION

### Technical Problem

However, there is a problem in that the temperature sensor assembly is not easy to assemble. For example, the temperature sensor assembly includes a pressing element for securing the temperature sensor and a sealing element for securing multiple housings. When assembling the temperature sensor assembly, it is necessary to use such pressing and sealing elements, which makes the assembly process more difficult.

An example of a conventional sensor module is illustrated in FIG. 9. FIG. 9 is an example of the external view illustrating the configuration of a conventional sensor module 100. The upper figure of FIG. 9 is a perspective view of the sensor module 100. The lower figure of FIG. 9 is a side view of the sensor module 100.

The sensor module 100 is a sensor module that outputs a signal received from a sensor 130 through a receptacle 140 via a wiring 170. The sensor module 100 encloses the sensor 130 inside a housing 110. The sensor 130 is mounted on a sensor substrate 120, and the sensor substrate 120 is secured to a lower housing 112. The receptacle 140 is fastened to the lower housing 112 via a packing 150 using a nut 160.

When assembling the sensor module 100, the operator first solders the wiring 170 to the receptacle 140. The operator then passes the wiring 170 through an opening of the lower housing 112 and the nut 160, and secures the receptacle 140 to the lower housing 112 from the inside using the nut 160. In FIG. 9, the receptacle 140 is of the front-mount type, but even in the case of a rear-mount type, the process of securing the receptacle 140 to the lower housing 112 is still required.

Then, the operator secures the sensor substrate 120 to the lower housing 112. Examples of a method for securing include securing the sensor substrate 120 using an adhesive. In addition, the operator solders the wiring 170 to the sensor substrate 120 inside the lower housing 112. Here, the order of securing the sensor substrate 120 to the lower housing 112 and soldering the wiring 170 to the sensor substrate 120 may be reversed. Finally, the operator completes the assembly of the sensor module 100, which includes the sensor 130 inside the housing 110, by attaching the upper housing 111 to the top of the lower housing 112.

Thus, when assembling the conventional sensor module 100, the process of securing the receptacle 140 to the lower housing 112 using the nut 160, as well as the process of soldering the wiring 170 to the sensor substrate 120, are performed inside the lower housing 112. Thus, the conventional sensor module 100 has a problem in that it is not easy to assemble.

In addition, in the conventional sensor module 100, it is necessary to secure the receptacle 140 to the lower housing 112 via the packing 150. Thus, the conventional sensor module 100 also has problems in that miniaturization is difficult due to the large number of components and the complexity of its structure, and it is costly to manufacture.

In addition, since it is difficult to miniaturize the conventional sensor module 100, for example, when installing it in a linear motion guide device, the location where the sensor module 100 can be installed is restricted. There is also a problem in that the sensor module 100 restricts the movement of the movable part of the linear motion guide device. In order to achieve miniaturization, the sensor module 100 may have a configuration in which the receptacle 140 is not used, and a cable for outputting signals from the sensor 130 is directly connected to the sensor substrate 120. However, even in this configuration, there is still a problem in that the risk of cable breakage arises during installation in the linear motion guide device or during cable routing.

An aspect of the present invention has been made in view of these problems, and an object thereof is to provide a technique for improving the workability of installing the sensor module.

### Solution to Problem

To achieve the object, a sensor module in accordance with an aspect of the present invention includes a housing that encloses a sensor, the housing including a receptacle formed therein with a shape configured to allow connection to an external plug, the housing having secured thereto a sensor substrate, on which the sensor and a pin module are mounted, the pin module having a contact pin configured to output a signal from the sensor inside the receptacle.

To achieve the object, a sensor-equipped linear motion guide device in accordance with an aspect of the present invention includes: a housing that encloses a sensor; and a guide rail extending in a predetermined direction and receiving a guide block installed in a slidable manner along the predetermined direction, a recess being formed at an end of the guide rail and being open on an end side, at least a part of the housing being fitted into the recess.

To achieve the object, a linear motion guide device in accordance with an aspect of the present invention includes a guide rail extending in a predetermined direction and receiving a guide block installed in a slidable manner along the predetermined direction, a recess being formed at an end of the guide rail and being open on an end side, the recess being configured to fit thereinto at least a part of a housing that encloses a sensor.

### Advantageous Effects of Invention

According to an aspect of the present invention, it is possible to improve the workability of installing the sensor module.

### BRIEF DESCRIPTION OF DRAWINGS

FIG. 1 is an example of the external view illustrating the configuration of a sensor module in accordance with Embodiment 1 of the present invention.

FIG. 2 is an example of the external view of the sensor module in accordance with Embodiment 1 of the present invention and an external plug.

FIG. 3 is a simplified diagram comparing the size of an example of the sensor module in accordance with Embodiment 1 of the present invention with the size of an example of a conventional sensor module.

FIG. 4 is an example of a perspective view illustrating a state in which the sensor module in accordance with Embodiment 1 of the present invention is mounted in an end of a guide rail.

FIG. 5 is an example of the external view of the end of the guide rail in accordance with Embodiment 1 of the present invention.

FIG. 6 is another example of the external view of the sensor module in accordance with Embodiment 1 of the present invention and the external plug.

FIG. 7 is an example of the external view of a connector-output sensor module in accordance with Embodiment 1 of the present invention and that of a cable-output sensor module.

FIG. 8 is an example of the external view illustrating a state in which the sensor module in accordance with Embodiment 1 of the present invention is mounted on a ball screw.

FIG. 9 is an example of the external view illustrating the configuration of a conventional sensor module.

### DESCRIPTION OF EMBODIMENTS

### Embodiment 1

The following description will discuss in detail an embodiment of the present invention.

### Configuration of Sensor Module 1

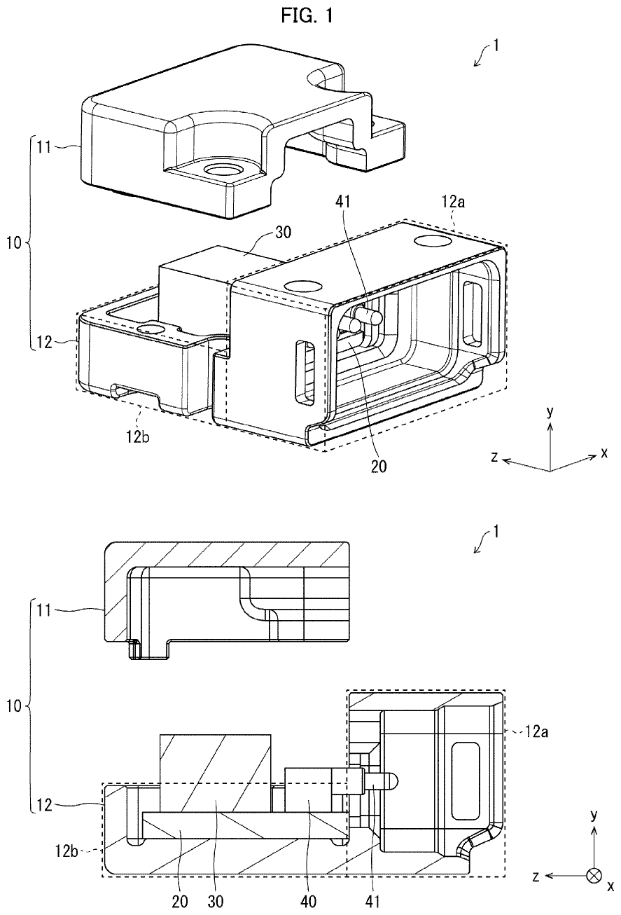

The configuration of a sensor module 1 in accordance with the present embodiment will be described with reference to FIG. 1. FIG. 1 is an example of the external view illustrating the configuration of the sensor module 1 in accordance with the present embodiment. The upper figure of FIG. 1 is a perspective view of the sensor module 1. The lower figure of FIG. 1 is a side view of the sensor module 1.

As illustrated in FIG. 1, the sensor module 1 includes a housing 10 that encloses a sensor 30. The housing 10 includes an upper housing 11 and a lower housing 12. The sensor module 1 also includes a sensor substrate 20, a sensor 30, and a pin module 40.

Hereunder, as illustrated in FIG. 1, when the sensor module 1 is installed with the sensor substrate 20 positioned on the lower side and the opening of a receptacle 12a is viewed from the front, the axis along the right-and-left direction is defined as the x-axis, the axis along the vertical direction as the y-axis, and the axis along the direction perpendicular to both the x-axis and the y-axis as the z-axis.

The housing 10 encloses the sensor 30 by fitting the upper housing 11 and the lower housing 12 together. In the lower housing 12, the receptacle 12a, which has a shape that allows connection to an external plug, and a substrate mounting section 12b are formed. To the substrate mounting section 12b, secured is the sensor substrate 20, on which the sensor 30 and a pin module 40 having contact pins 41 configured to output a sensor signal inside the receptacle 12a are mounted.

The sensor substrate 20 is a circuit board on which the sensor 30 and the pin module 40 are mounted.

The sensor 30 outputs a signal indicating the detected environmental changes. What environmental changes the sensor 30 detects are not particularly limited. An example of the sensor 30 may be a vibration sensor that detects vibrations.

The pin module 40 is a module having the contact pins 41 configured to be electrically connected to the socket of the external plug 2. The pin module 40 is mounted on the sensor substrate 20 so that, when the sensor substrate 20 is secured to the lower housing 12 and the external plug 2 is connected to the receptacle 12a, the contact pins 41 are positioned to make contact with the socket of the external plug 2 (hereinafter referred to as the “predetermined position”).

The sensor module 1 outputs a signal received from the sensor 30 via the contact pins 41. As an example, the sensor module 1 outputs the signal received from the sensor 30, to an external device by connecting the external plug 2, which is connected to the external device, to the receptacle 12a.

### Example 1 of Sensor Module 1 and External Plug 2

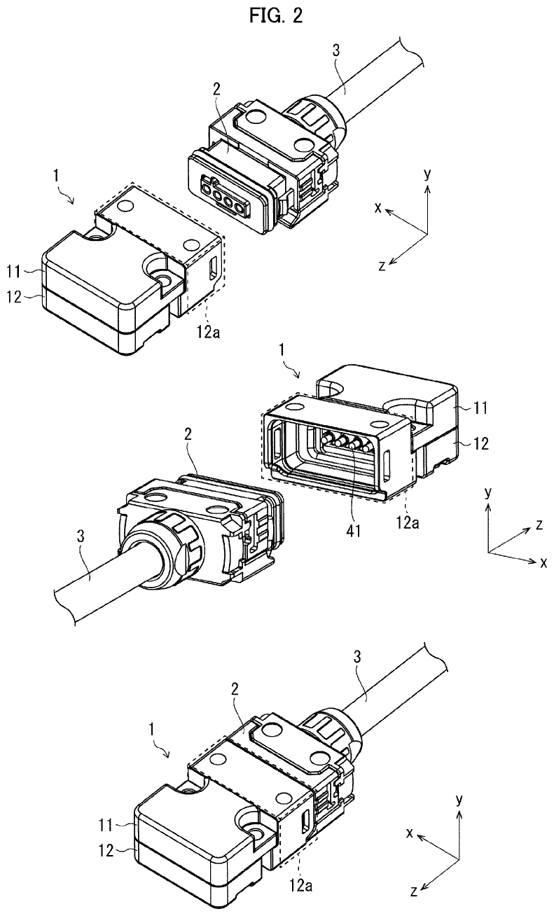

The sensor module 1 and the external plug 2 will be described with reference to FIG. 2. FIG. 2 is an example of the external view of the sensor module 1 in accordance with the present embodiment and the external plug 2. The upper figure of FIG. 2 is a perspective view illustrating a state in which the sensor module 1 and the external plug 2 are not connected, viewed from the opposite side of the opening of the receptacle 12a of the sensor module 1. The center of FIG. 2 is a perspective view illustrating the state in which the sensor module 1 and the external plug 2 are not connected, viewed from the front side of the opening of the receptacle 12a of the sensor module 1. The lower figure of FIG. 2 is a perspective view illustrating a state in which the sensor module 1 and the external plug 2 are connected, viewed from the opposite side of the opening of the receptacle 12a of the sensor module 1.

As illustrated in the upper figure and center of FIG. 2, the receptacle 12a, which has a shape that allows connection to the external plug 2, is formed in the lower housing 12. Further, as illustrated in the lower figure of FIG. 2, when the receptacle 12a and the external plug 2 are connected, the receptacle 12a and the external plug 2 are fitted together. Then, a signal received from the sensor 30 is transmitted via a cable 3 connected to the external plug 2 to the external device connected to the other end of the cable 3.

### Comparison of Sizes with Conventional Sensor Module 100a

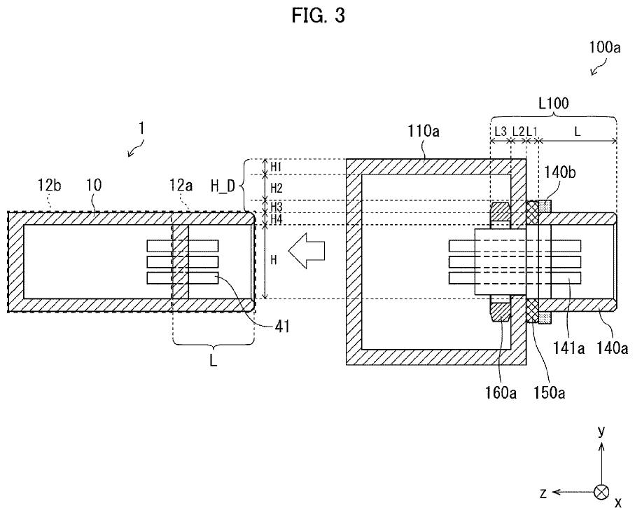

The comparison of the sizes between the sensor module 1 in accordance with the present embodiment and a conventional sensor module 100a will be described with reference to FIG. 3. FIG. 3 is a simplified diagram comparing the configurations of an example of the sensor module 1 in accordance with the present embodiment and an example of the conventional sensor module 100a.

As illustrated in FIG. 3, in the conventional sensor module 100a, a receptacle 140a is secured to a housing 110a using a nut 160a. Between the receptacle 140a and the housing 110a, a packing 150a is placed. A signal from a sensor (not illustrated in FIG. 3) installed inside the housing 110a is outputted via contact pins 141a inside the receptacle 140a.

In FIG. 3, described is an example in which the thickness (H4) of the housing 10 of the sensor module 1, the thickness (H1 and L2) of the housing 110a of the sensor module 100a, and the thickness (H4) of the housing of the receptacle 140a are all the same (H1=H4=L2). Further, a case where the vertical length (in the y-axis direction) of the opening of the receptacle 12a of the sensor module 1 and the vertical length of the opening of the receptacle 140a of the sensor module 100a are also the same (H) is described. Still further, a case where the longitudinal length (in the z-axis direction) of the opening of the receptacle 12a of the sensor module 1 and the longitudinal length of the opening of the receptacle 140a of the sensor module 100a are also the same (L) is described. Additionally, a case where the longitudinal length (in the z-axis direction) of the substrate mounting section 12b of the sensor module 1 and the longitudinal length of the housing 110a of the sensor module 100a are also the same is described.

First, the longitudinal length of the conventional receptacle 140a and that of the receptacle 12a in accordance with the present embodiment will be compared. The longitudinal length of the conventional receptacle 140a is represented by L100, which is the sum of the length L of the opening of the receptacle 140a, the thickness L1 of the packing, the thickness L2 of the housing 110a, and the thickness L3 of the nut 160a.

On the other hand, the longitudinal length of the receptacle 12a in accordance with the present embodiment is the length L of the opening of the receptacle 12a. That is, as illustrated in FIG. 3, the longitudinal length of the receptacle 12a in accordance with the present embodiment is shorter than the longitudinal length of the conventional receptacle 140a by (L100−L).

Additionally, as illustrated in FIG. 3, the longitudinal length of the sensor module 1 in accordance with the present embodiment is shorter than the longitudinal length of the conventional sensor module 100a by the sum of the length L1 of the packing 150a and the thickness L2 of the housing 110a (L1+L2).

Next, the vertical length of the conventional receptacle 140a and that of the receptacle 12a in accordance with the present embodiment will be compared. The vertical length of the conventional receptacle 140a is represented by {H+(H3×2)+(H4×2)}, which is the sum of the length H of the opening of the receptacle 140a, the length (H3×2) of a flange section 140b of the receptacle 140a, and the thickness (H4×2) of the housing of the receptacle 140a.

On the other hand, the vertical length of the receptacle 12a in accordance with the present embodiment is represented by {H+(H4×2)}, which is the sum of the length H of the opening of the receptacle 12a and the thickness (H4×2) of its housing. That is, as illustrated in FIG. 3, the vertical length of the receptacle 12a in accordance with the present embodiment is shorter than the vertical length of the conventional receptacle 140a by [{H+(H3×2)+(H4×2)}−{H+(H4×2)}]=(H3×2).

Next, the vertical length of the conventional sensor module 100a and the sensor module 1 in accordance with the present embodiment will be compared. First, the lengths of the upper side of the receptacles will be compared. The length of the upper side of the receptacle of the conventional receptacle 140a is represented by (H1+H2+H3+H4), which is the sum of the thickness H1 of the housing 110a, the length H2 from the upper end of the flange section 140b to the housing 110a, the length H3 of the flange section 140b, and the thickness H4 of the housing of the receptacle 140a.

On the other hand, the length of the upper side of the receptacle of the sensor module 1 in accordance with the present embodiment is the thickness H4 of the housing 10. That is, as illustrated in FIG. 3, the length of the upper side of the receptacle in the vertical direction of the sensor module 1 in accordance with the present embodiment is shorter than that of the conventional sensor module 100a by (H1+H2+H3+H4)−H4=H1+H2+H3 (denoted as H_D in FIG. 3).

Similarly, with respect to the lower side of the receptacle, the vertical length of the sensor module 1 in accordance with the present embodiment is shorter than the vertical length of the conventional sensor module 100a by the length H_D. That is, the vertical length of the sensor module 1 in accordance with the present embodiment is shorter than the vertical length of the conventional sensor module 100a by (H_D×2).

Thus, the sensor module 1 can reduce its longitudinal and vertical dimensions compared with the conventional design by forming the receptacle 12a in the lower housing 12.

### Assembly of Sensor Module 1

When assembling the sensor module 1, the operator secures the sensor substrate 20, on which the sensor 30 and the pin module 40 are mounted, to the lower housing 12 so that the contact pins 41 of the pin module 40 are arranged at predetermined positions inside the receptacle 12a. The method for securing the sensor substrate 20 to the lower housing 12 is not particularly limited, and, as an example, a method of securing it using an adhesive may be used. Finally, the operator fits the upper housing 11 and the lower housing 12 together.

### Advantageous Effects of Sensor Module 1

Thus, the sensor module 1 does not require soldering inside the lower housing 12. Also, since the receptacle 12a is formed in the lower housing 12, the sensor module 1 does not require any components for securing the receptacle 12a. Thus, the sensor module 1 facilitates ease of assembly and enables the realization of a sensor module with a simplified structure. In addition, in the sensor module 1, by pre-mounting the pin module 40 on the sensor substrate 20 using an automated machine, the soldering work by the operator can also be eliminated. Moreover, since the sensor module 1 is miniaturized compared with the conventional sensor module 100a, it improves the workability of installing the sensor module 1.

Alternatively, in the lower housing 12, the substrate mounting section 12b to which the sensor substrate 20 is secured and the portion in which the receptacle 12a is formed may be integrally molded.

With this configuration, the sensor module 1 eliminates the need for work to integrate the substrate mounting section 12b and the receptacle 12a, as well as the need for components such as packing. Thus, the sensor module 1 facilitates ease of assembly and enables the realization of a sensor module with a simplified structure.

### Mounting Example 1 of Sensor Module 1

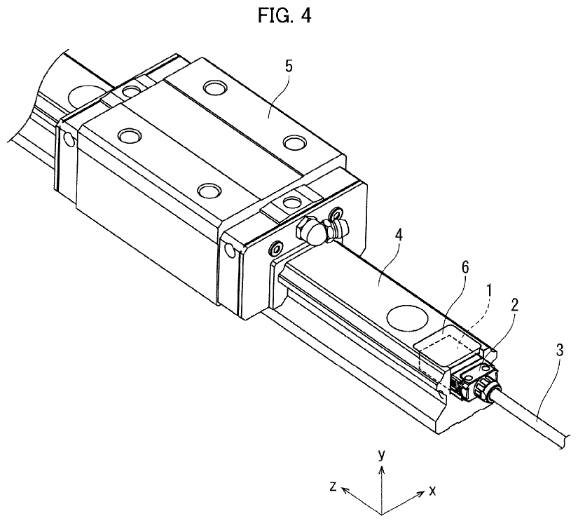

A mounting example of the sensor module 1 will be described with reference to FIG. 4. FIG. 4 is an example of a perspective view illustrating the state in which the sensor module 1 in accordance with the present embodiment is mounted in an end of a guide rail 4 in a linear motion guide device. That is, the linear motion guide device illustrated in FIG. 4 is a sensor-equipped linear motion guide device that includes the housing 10 that encloses the sensor module 1, and the guide rail 4. The linear motion guide device may be for use in, for example, machine tools, semiconductor manufacturing equipment, and industrial robots.

As illustrated in FIG. 4, the sensor module 1 may be installed at the end of the guide rail 4 that extends in a predetermined direction (in the z-axis direction in FIG. 4) and receives a guide block 5 installed in a slidable manner along the predetermined direction. Additionally, a cover 6 is arranged on the upper side of the sensor module 1 in the y-axis direction.

Thus, by installing the sensor module 1 at the end of the guide rail 4, the wiring to a cable chain for organizing cable arrangements can be reduced compared with a case where the sensor module 1 is installed at a location other than the end of the guide block 5. Further, by reducing the wiring to the cable chain, the length of the cable 3 can be shortened. In addition, by reducing wiring points to movable parts such as the guide block 5, the risk of cable 3 breakage can be reduced.

### Example 1 of Mounting Method for Sensor Module 1

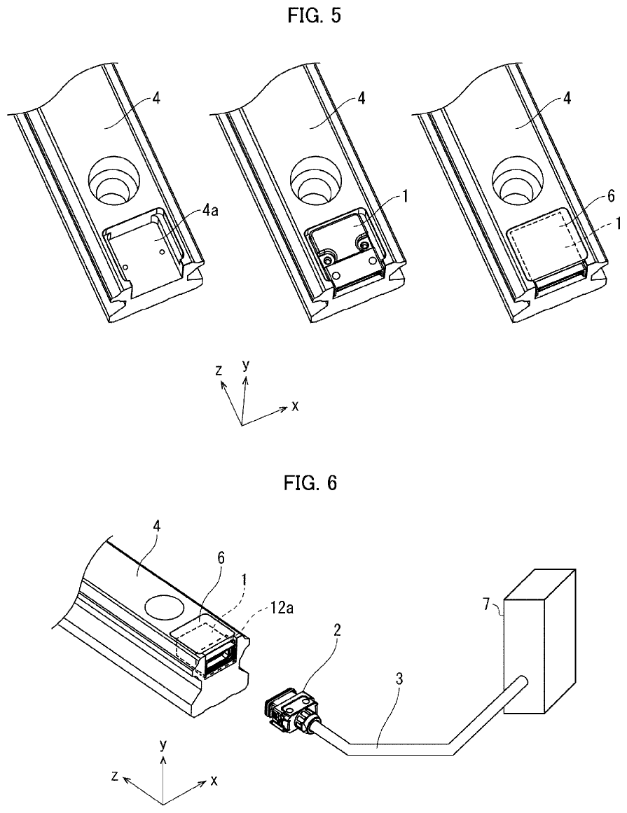

In FIG. 4, the sensor module 1 is mounted in the end of the guide rail 4 by fitting into a recess 4a formed at the end of the guide rail 4. The method for mounting the sensor module 1 in the recess 4a will be described with reference to FIG. 5. FIG. 5 is an example of the external view of the end of the guide rail 4 in accordance with the present embodiment. The left figure of FIG. 5 is a perspective view of the end of the guide rail 4 before the sensor module 1 is mounted therein. The center of FIG. 5 is a perspective view of the end of the guide rail 4 after the sensor module 1 is mounted therein. The right figure of FIG. 6 is a perspective view of the end of the guide rail 4 after the cover 6 is attached.

As illustrated on the left figure of FIG. 5, the recess 4a is formed at the end of the guide rail 4 and is open on the end side. In FIG. 5, the recess 4a is formed in a shape that allows the entire housing 10 of the sensor module 1 to fit into it. However, the recess 4a may be formed in a shape that allows at least a part of the housing 10 of the sensor module 1 to fit into it. That is, the recess 4a only needs to be formed such that, when the housing 10 of the sensor module 1 is fitted into it, the sensor module 1 is secured at the end of the guide rail 4. For example, the recess 4a may be formed such that half of the length of the housing 10 along the z-axis direction fits into the recess 4a.

Next, as illustrated in the center of FIG. 5, the housing 10 is fitted into the recess 4a. Finally, as illustrated on the right figure of FIG. 5, the cover 6 is placed on the upper side of the sensor module 1 in the y-axis direction. It should be noted that the cover 6 may or may not be placed. By placing the cover 6, it is possible to eliminate the depression on the surface of the guide rail 4. By eliminating the depression on the surface of the guide rail 4, it is possible to prevent foreign matter from accumulating in the depression (such as mounting screws) on the upper surface of the upper housing 11 of the sensor module 1. This helps to avoid foreign matter being carried into the interior of the guide block 5 when the guide block 5 slides.

Thus, by installing the sensor module 1 such that at least a part of the housing 10 of the sensor module 1 fits into the recess 4a formed at the end of the guide rail 4, the sensor module 1 can be positioned in a location that does not interfere with the movement of the guide block 5. When the sensor 30 of the sensor module 1 is a vibration sensor, it can suitably detect vibrations of the guide rail 4.

By forming at the end of the guide rail 4 the recess 4a, into which at least a part of the housing 10 of the sensor module 1 fits, so that it is open on the end side, the sensor module 1 can be retrofitted to the guide rail 4. Further, if a failure occurs in the sensor module 1, the sensor module 1 can be easily replaced. In addition, the sensor module 1 can be installed and replaced even with the guide block 5 remaining mounted to the guide rail 4. That is, the linear motion guide device illustrated in, for example, FIG. 4 can improve the workability of installing the sensor module 1.

Furthermore, the sensor module 1 can be manufactured separately from the guide rail 4. Thus, unlike conventional cases where the sensor module and the guide rail are integrated, making mass production and inventory management difficult due to the variety in the shapes and lengths of guide rails, the sensor module 1 allows for easier mass production and inventory management.

As described above, the sensor module 1 is miniaturized compared with the conventional sensor module 100a. Thus, as illustrated in FIGS. 4 and 5, in a state in which at least a part of the housing 10 is fitted into the recess 4a, the cross-sectional size of the sensor module 1 in a plane perpendicular to the sliding direction (the z-axis direction) of the guide block 5 (i.e., a plane parallel to the xy-plane) can be made smaller than the cross-sectional size of the guide rail 4 in the plane perpendicular to the sliding direction of the guide block 5.

In other words, when the sensor module 1 is installed on the guide rail 4, the sensor module 1 is positioned within the guide rail 4 in every cross-section on a plane parallel to the xy-plane of the guide rail 4. That is, when the sensor module 1 is installed on the guide rail 4, in every cross-section on a plane parallel to the xy-plane of the guide rail 4, the length of the sensor module 1 along the x-axis is shorter than the length of the guide rail 4 along the x-axis. Also, when the sensor module 1 is installed on the guide rail 4, in every cross-section on a plane parallel to the xy-plane of the guide rail 4, the length of the sensor module 1 along the y-axis is shorter than the length of the guide rail 4 along the y-axis.

Thus, since the sensor module 1 is installed within the range of the cross-section of the guide rail 4, it does not restrict the movable range of the guide block 5.

### Example 2 of Sensor Module 1 and External Plug 2

The sensor module 1, which is installed at the end of the guide rail 4, and the external plug 2 will be described with reference to FIG. 6. FIG. 6 is another example of the external view of the sensor module 1 in accordance with the present embodiment and the external plug 2.

As illustrated in FIG. 6, the external plug 2 is connected to an external device 7 via the cable 3. By connecting the external plug 2 to the sensor module 1, the external device 7 can acquire a signal outputted by the sensor 30. An example of the external device 7 may be a signal measuring instrument with a calculation function, but it is not limited thereto.

As illustrated in FIG. 6, the receptacle 12a of the sensor module 1 may be formed in the housing 10 so as to allow the external plug 2 to be connected at the end of the guide rail 4 in the same direction as the sliding direction (the z-axis direction) of the guide block 5 on the guide rail 4. With this configuration, it is possible to suitably prevent the external plug 2 from restricting the movement of the guide block 5.

As illustrated in FIG. 6, the sensor module 1 does not require the use of an intermediate connector between the sensor module 1 and the external device 7. Thus, in the sensor module 1, since there is no need for a location to secure an intermediate connector, the cable can be secured at any desired location.

### Comparison with Sensor Module 100b Integrated with External Plug 2 and Cable 3

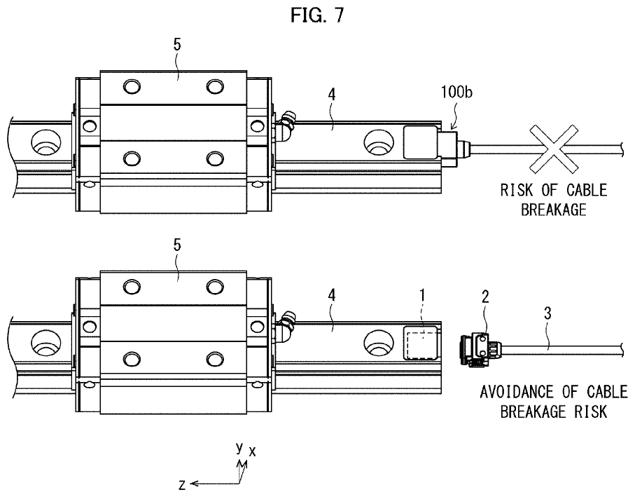

The following description will discuss, with reference to FIG. 7, a comparison between a case where a sensor module 100b, which is integrated with the external plug 2 and the cable 3 (hereinafter referred to as the “cable-output sensor module 100b”), is installed at the end of the guide rail 4, and a case where the sensor module 1 in accordance with the present embodiment (hereinafter referred to as the “connector-output sensor module 1”), is installed at the end of the guide rail 4. FIG. 7 is an example of the external view of the connector-output sensor module 1 in accordance with the present embodiment and that of the cable-output sensor module 100b. The upper figure of FIG. 7 is an example of the external view illustrating the state in which the cable-output sensor module 100b is installed at the end of the guide rail 4. The lower figure of FIG. 7 is an example of the external view illustrating the state in which the connector-output sensor module 1 is installed at the end of the guide rail 4. Here, the cable-output sensor module 100b is configured so that the sensor module 100b, the external plug 2, and the cable 3 are integrated, and the sensor module 100b, the external plug 2, and the cable 3 cannot be separated from each other.

As illustrated in the upper figure of FIG. 7, when the cable-output sensor module 100b is installed at the end of the guide rail 4, there is a risk of the cable 3 breaking when the guide rail 4 is installed. On the other hand, as illustrated in the lower figure of FIG. 7, the connector-output sensor module 1 is separated from the external plug 2, which prevents the cable 3 from breaking when the guide rail 4 is installed.

### Mounting Example 2 of Sensor Module 1

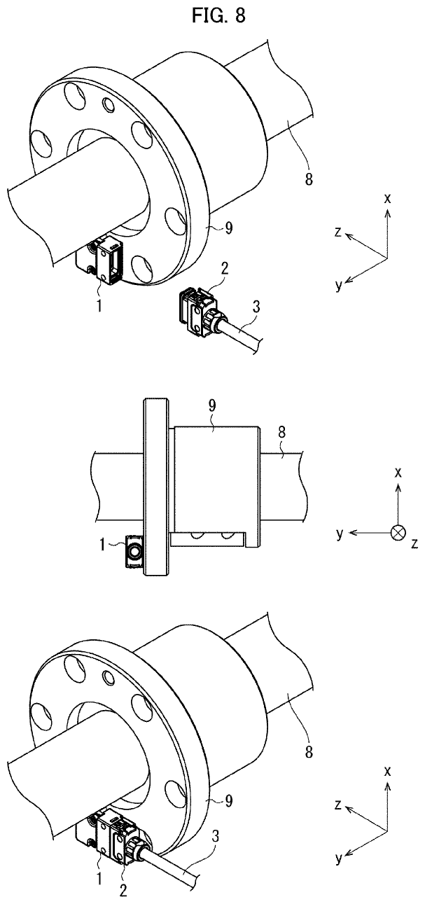

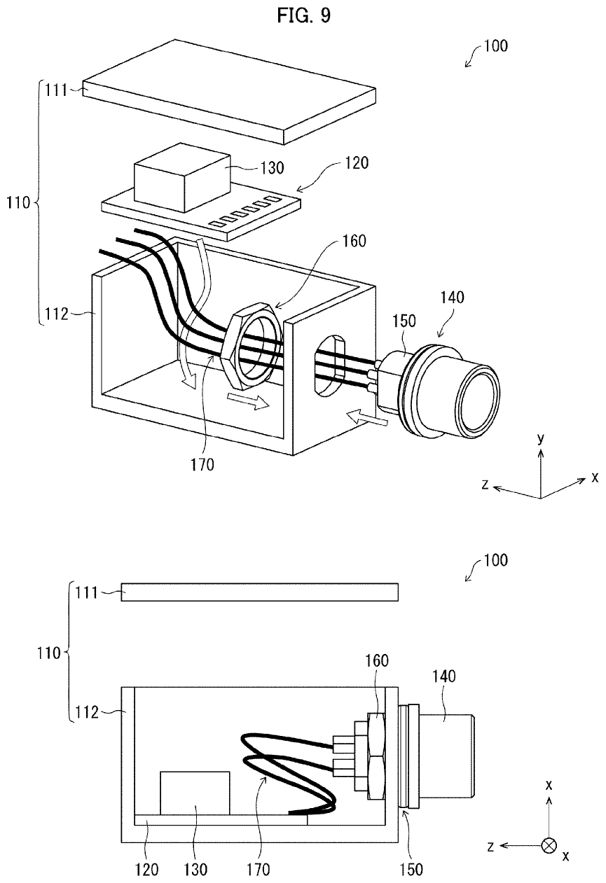

Another mounting example of the sensor module 1 will be described with reference to FIG. 8. FIG. 8 is an example of the external view illustrating the state in which the sensor module 1 in accordance with the present embodiment is mounted on a ball screw 9. The upper figure of FIG. 8 is a perspective view illustrating a state in which the sensor module 1 and the external plug 2 are not connected. The center of FIG. 8 is a side view illustrating the state in which the sensor module 1 and the external plug 2 are not connected. The lower figure of FIG. 8 is a perspective view illustrating a state in which the sensor module 1 and the external plug 2 are connected.

The ball screw 9 illustrated in FIG. 8 is a screw that engages with a screw shaft 8 and moves along the axial direction of the screw shaft 8 (the y-axis direction) as the screw shaft 8 rotates. As illustrated in FIG. 8, the sensor module 1 may be mounted on the ball screw 9.

Thus, by setting the sensor module 1 on the ball screw 9, the sensor module 1 can suitably detect vibrations of the ball screw 9 when the sensor 30 is a vibration sensor. In addition, since the sensor module 1 is separated from the external plug 2, only the sensor module 1 can be easily replaced. That is, the sensor module 1 can improve the workability of installing the sensor module 1.

Furthermore, as illustrated in FIG. 8, the sensor module 1 may be mounted on the surface of the ball screw 9 in a plane perpendicular to the axial direction of the screw shaft 8 (the xz-plane).

As described above, since the sensor module 1 is miniaturized compared with conventional ones, this configuration allows the dimension of the sensor module 1 in the axial direction of the screw shaft 8 to be small, thereby minimizing interference with the movement of the ball screw 9.

The present invention is not limited the embodiments, but can be altered by a skilled person in the art within the scope of the claims. The present invention also encompasses, in its technical scope, any embodiment derived by combining technical means disclosed in differing embodiments.

### REFERENCE SIGNS LIST

1 Sensor module
2 External plug
3 Cable
4 Guide rail
5 Guide block
10 Housing
11 Upper housing
12 Lower housing
12a Receptacle
12b Substrate mounting section
20 Sensor substrate
30 Sensor
40 Pin module
41 Contact pins

1. A sensor module comprising a housing that encloses a sensor,
the housing including a receptacle formed therein with a shape configured to allow connection to an external plug,
the housing having secured thereto a sensor substrate, on which the sensor and a pin module are mounted, the pin module having a contact pin configured to output a signal from the sensor inside the receptacle.

2. The sensor module according to claim 1, wherein at least a part of the housing is configured to fit into a recess that is formed at an end of a guide rail and is open on an end side, the guide rail extending in a predetermined direction and receiving a guide block installed in a slidable manner along the predetermined direction.

3. The sensor module according to claim 2, wherein in a state in which the at least a part of the housing is fitted into the recess, a cross-sectional size of the sensor module in a plane perpendicular to the sliding direction of the guide block is smaller than a cross-sectional size of the guide rail in the plane perpendicular to the sliding direction.

4. The sensor module according to claim 1, wherein the sensor module is configured to be mounted on a ball screw engaging with a screw shaft and moving along an axial direction of the screw shaft as the screw shaft rotates.

5. The sensor module according to claim 4, wherein the sensor module is configured to be mounted on a surface of the ball screw in a plane perpendicular to the axial direction.

6. The sensor module according to claim 1, wherein a portion of the housing to which the sensor substrate is secured and a portion of the housing in which the receptacle is formed are integrally molded.

7. A sensor-equipped linear motion guide device comprising:
a housing that encloses a sensor; and
a guide rail extending in a predetermined direction and receiving a guide block installed in a slidable manner along the predetermined direction,
a recess being formed at an end of the guide rail and being open on an end side,
at least a part of the housing being fitted into the recess.

8. A linear motion guide device comprising a guide rail extending in a predetermined direction and receiving a guide block installed in a slidable manner along the predetermined direction,
a recess being formed at an end of the guide rail and being open on an end side, the recess being configured to fit thereinto at least a part of a housing that encloses a sensor.
